(19) United States
(12) Patent Application Publication
(10) Pub. No.: US 2012/0173250 A1
(43) Pub. Date: Jul. 5, 2012

(54) BEHAVIOR BASED LOYALTY SYSTEM TO DELIVER PERSONALIZED BENEFITS

(75) Inventors: Keith Ward Jeffrey, Seattle, WA (US); Scott Kenneth Bishop, Seattle, WA (US); Bruno Caiado, Issaquah, WA (US); Mahesh K. J. Nemichand, Redmond, WA (US); Alexander G. Selkirk, Brooklyn, NY (US); David Dehghan, Seattle, WA (US)

(73) Assignee: MICROSOFT CORPORATION, Redmond, WA (US)

(21) Appl. No.: 12/983,063

(22) Filed: Dec. 31, 2010

(51) Int. Cl. G06Q 30/00

(52) U.S. Cl. 705/1.1

(57) ABSTRACT

A suggested communication from a plurality of available communications for the user may be determined. The suggested communication may be created specifically for a user or for users in one or more categories. If the suggested communication is determined to be sufficiently similar to the profile of the user, the suggested communication may be provided to the user and the suggested communication may be removed from the available communications for the user for a period of time. A computer usage message may be received indicating whether the suggestion communication was acted upon or not acted upon. If the user responded in a desired way, a benefit may be provided to the user and an additional analysis of the response computer usage message communicated from the user may be performed.

### BACKGROUND

Trying to create and timely communicate effective offers and communications to users to encourage new or repeat behavior has been an increasing problem. In the past, bulk communications have been attempted with limited success. As electronic communication is relatively cheap, even a low response rate may make sending bulk communications economically effective. However, the receivers of these bulk communications may find the communications to be unwanted (i.e., SPAM) and may not be viewed as being worthwhile (i.e., relevant). With the volume of these communications that users receive it is often too difficult and costly for a specific message or company to “breakthrough” the clutter and attract attention.

Further, as users' interests may change over time, what communications interest a person in the past may not indicate what interests a person no longer be relevant. Traditional loyalty programs emerged to try and address this problem by providing a single benefit such as points to users to get them to perform a behavior most often tied to a direct transaction. With the advent and rapid growth of online content and services users face a problem of being able to “keep up” with and discover what could be meaningful and relevant to them and companies lack a way of providing targeted benefits to segments of users to encourage the trial, use and/or consumption of content and services they are offering.

### SUMMARY

A method of analyzing computer usage to deliver targeted, tailored communications to encourage behavior through offering benefits is disclosed. In one of the many embodiments of the claims, a computing usage message may be received. An analysis of the computer usage message from the user may be performed. A result of the analysis may be stored in a profile for the user. A suggested communication from a plurality of available communications for the user may be determined. The determination may entail selecting at least one of the many available communications as being most closely related to the profile of the user. It may be determined if the suggested communication is sufficiently similar to the profile of the user by, for example and not limitation, determining if the suggested communications ranks over a threshold of relevancy to the user profile.

If the suggested communication is determined to be sufficiently similar to the profile of the user, the suggested communication may be provided to the user and the suggested communication may be removed from the available communications for the user for a period of time. A response computer usage message may be received indicating whether the suggested communication was acted upon or not acted upon. If the suggested communication was acted upon and/or completed, a benefit may be provided to the user and an additional analysis of the response computer usage message communicated from the user may be performed. An additional result of the further analysis may be stored in the profile for the user. In addition, future communications may be tailored to better match the profile of a specific user or users in specific classifications as described later.

### DESCRIPTION OF THE DRAWINGS

FIG. 1 illustrates a sample computing device that may be physically configured according to computer executable instructions;

FIG. 2 illustrates steps that are executed by the physically configured computing device;

FIG. 3 illustrates a sample user profile;

FIG. 4 illustrates a sample list of available communications;.

FIG. 5 is an exemplary portion of a web page showing a toolbar and system button;

FIG. 6 is an exemplary screen shot showing a display with various promotions;

FIG. 7 is an exemplary screen shot of a system redemption page;

FIG. 8 is an illustration of the computing devices receiving suggested communications and communicating user communications; and

FIG. 9 is an illustration of a sample benefit system.

### SPECIFICATION

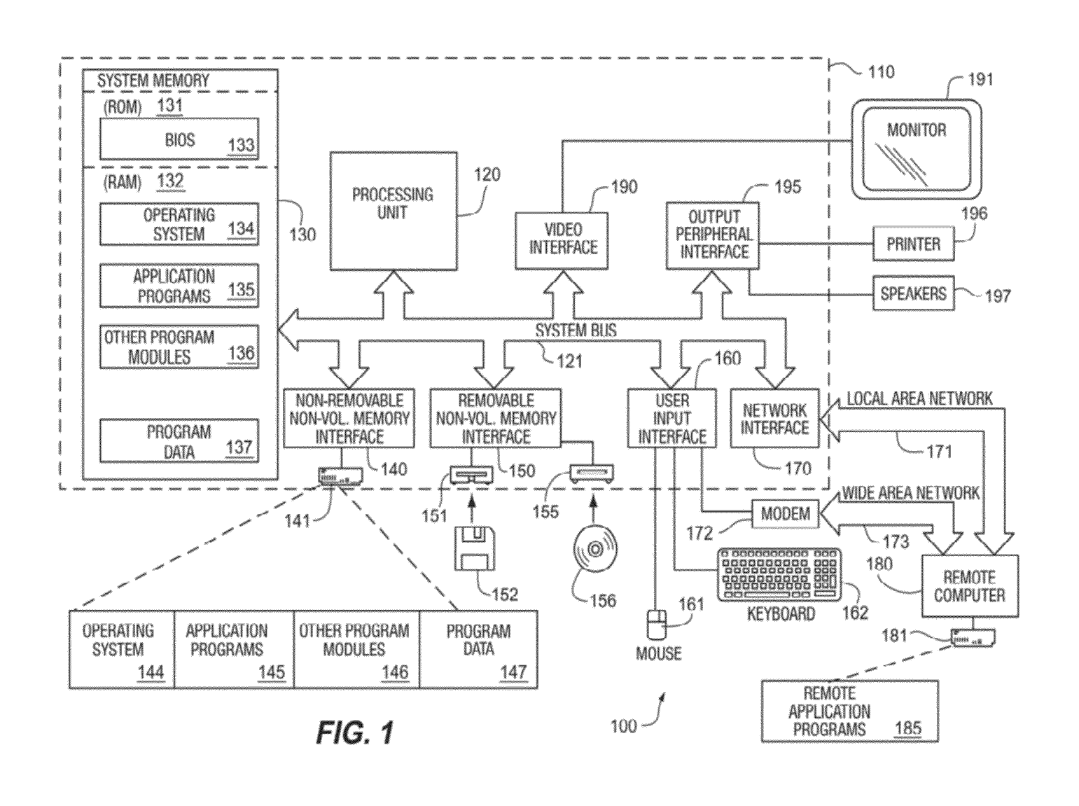

FIG. 1 illustrates an example of a suitable computing system environment 100 that may be physically configured to operate, display device and provide a shopper interface described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100. In one embodiment, the device described in the specification is entirely created out of hardware as a dedicated unit that is physically transformed according to the description of the specification and claims. In other embodiments, the device executes software and yet additional embodiment, the device is a combination of hardware that is physically transformed and software.

With reference to FIG. 1, an exemplary system that may be physically configured for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170. In addition, not all the physical components need to be located at the same place. In some embodiments, the processing unit 120 may be part of a cloud of processing units 120 or computers 110 that may be accessed through a network.

Computer 110 typically includes a variety of computer readable media that may be any available media that may be accessed by computer 110 and includes both volatile and nonvolatile media, removable and non-removable media. The system memory 130 may include computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150. However, none of the memory devices such as the computer storage media are intended to cover transitory signals or carrier waves.

A user may enter commands and information into the computer 110 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

In additional embodiments, the processing unit 120 may be separated into numerous separate elements that may be shut down individually to conserve power. The separate elements may be related to specific functions. For example, an electronic communication function that controls Wi-Fi, Bluetooth, etc, may be a separate physical element that may be turned off to conserve power when electronic communication is not necessary. Each physical elements may be physically configured according to the specification and claims described herein.

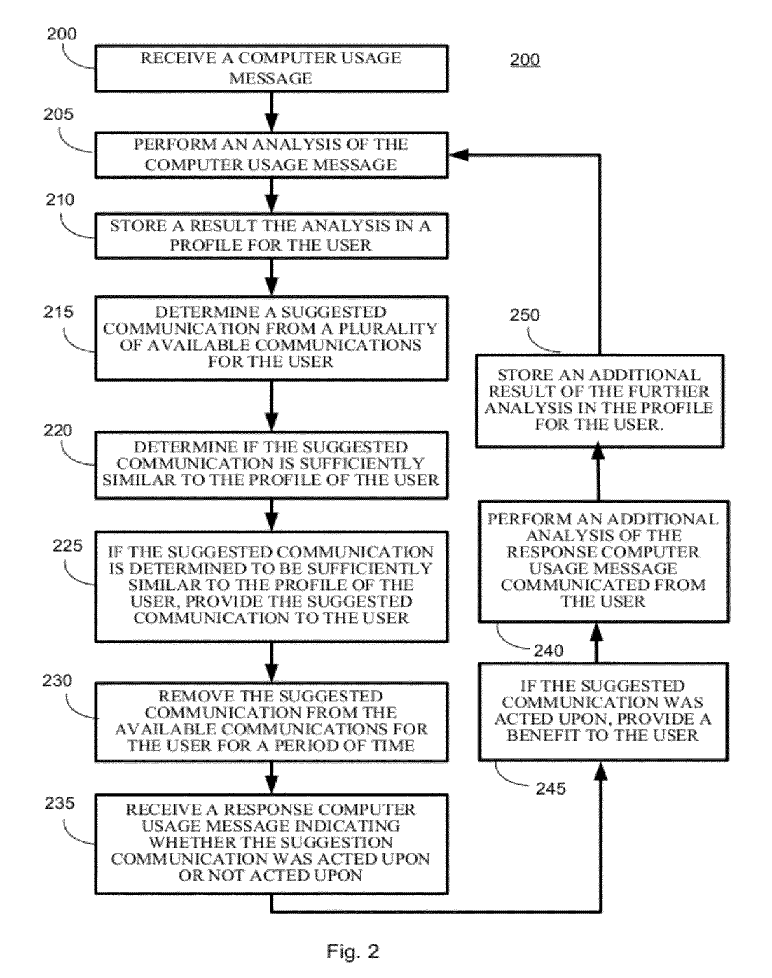

FIG. 2 may illustrate one embodiment out of many different embodiments of a method of analyzing computer usage to deliver targeted, tailored communications to encourage users to take a desired action. The computers 110 may include desktop computers, mobile devices, smart phones, laptops, tablet computers, entertainment devices including game consoles, etc. For convenience, the term computer will be used throughout this description, but the concepts discussed herein are equally applicable to the full range of electronic devices that are capable of supporting a user interface and direct or indirect communications via a network, such as the Internet and may include any of the above devices or their equivalent.

As mentioned briefly, electronic devices and the ability to communicate easily and cheaply with these devices had created opportunities to deliver messages and offers to consumers. Problems have arisen with the messages being viewed as “spam” or as being viewed as unwelcome as some message providers have not been careful about only forwarding messages that are relevant to the consumer receiving the message.

The various embodiments of the method attempt to create a user profile based system that learns about users in a non-threatening, inclusive way and presents a relevant mix of communications such as offers, promotions, etc., to users to earn benefits that logic predicts the users will find valuable for performing certain actions. The general idea of the system and method is to create loyalty in users by offering a relevant mix of benefits which is described further herein such that the users will perform desired repeat actions or try desired new actions. The user profile may be created by a user or a system may create the profile with approval from the user.

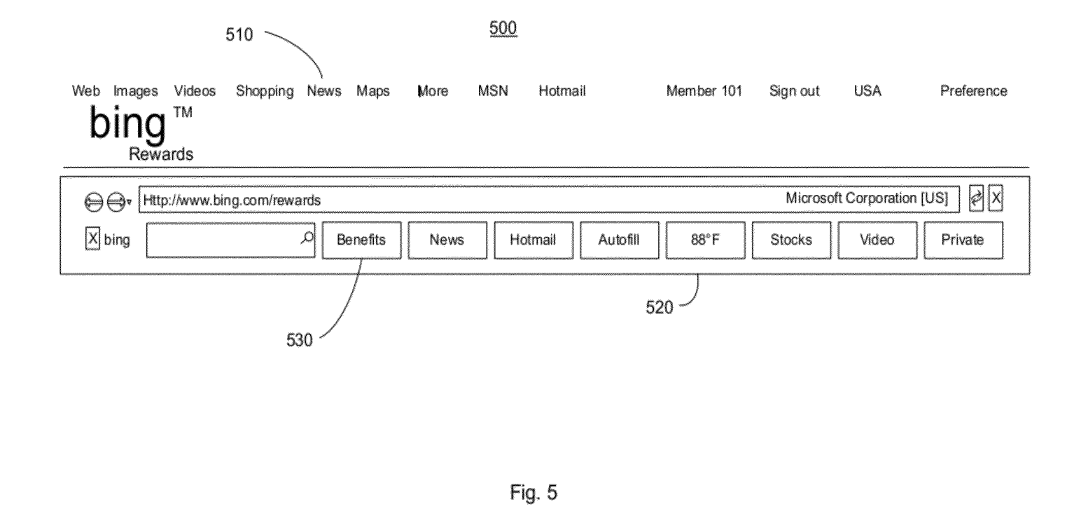

To encourage participation, in one embodiment, a notice may be sent to the user, for example, via a system application such as an internet browser or toolbar, that a particular promotion may be available if the user chooses to participate in one embodiment of the system. The notice may include a visual indicator(s) showing current status of a promotion, such as graphs of activities completed against a target number and days remaining in the promotion. This is certainly not the only way to notify a user of remaining tasks related to a promotion and other reminders may also be used to encourage participation, such as email, text alerts, or toolbar alerts. A sample toolbar may be displayed in FIG. 5 which will be discussed further in this patent. The notice may also mention that a benefit may be provided if the user participates and the benefit may be varied, either up or down, depending on how strong is the desire to have the particular user participate. Further, a vendor or partner may agree to participate and use the system to access a category of users, and pay for the benefit(s) that may be provided to the user if the user acts in a desired manner.

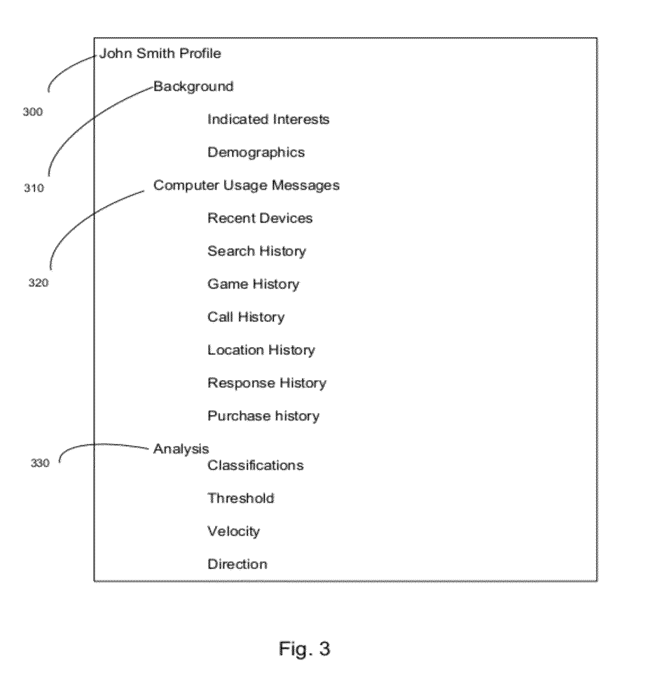

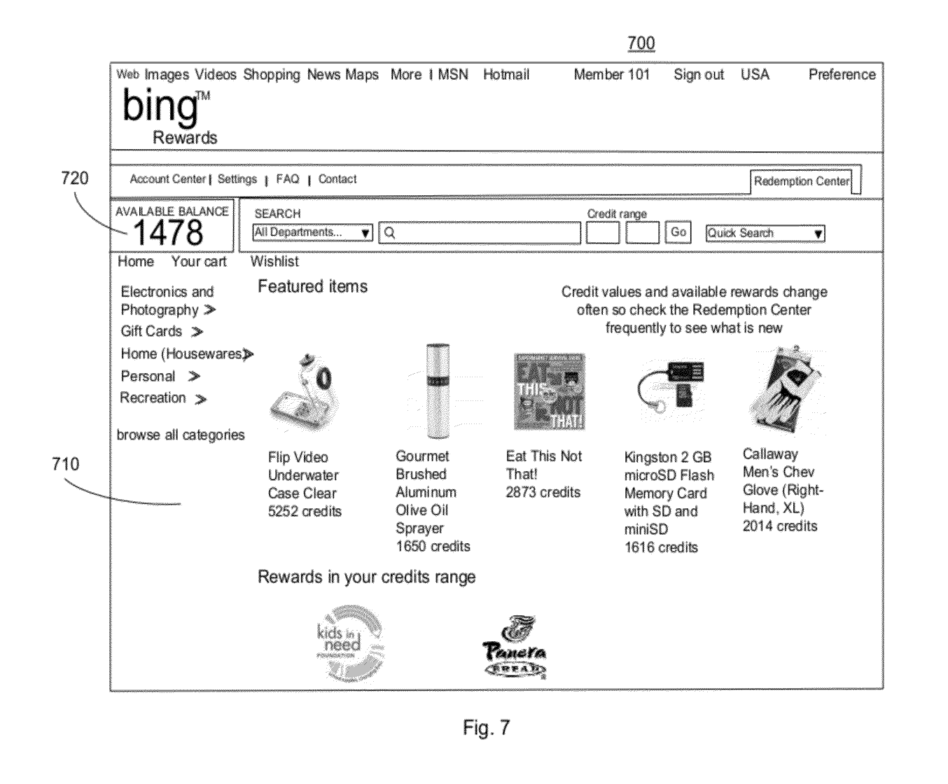

At block 200, a computing usage message may be received. The computing message 320 (FIG. 3) may be a communication from a computing device 110. At a high level, the computing message 320 may indicate that a user has undertaken an action related to a computing device 110. In some embodiments, the action may need to be completed and not just undertaken for a benefit 720 (FIG. 7) to be earned or accrued. The action could be as simple as opening an email or selecting a text message. The action could even be that a user did not take an action such as a user, did not view a communication, did not follow a suggested link, did not walk into a specific store, etc. Any action of the user that can be identified by a computing device 110 may be considered a computer usage message 320. In some embodiments, the computer usage message 320 may include a time stamp and a location, such as a GPS based location, a cell tower triangulation location, etc.

In some embodiments, the computer 110 that creates the computer usage message 320 may be a mobile computing device 110. The computer usage message 320 may be analyzed to create an analysis 330 to determine a velocity and direction of the user (using two location points and two time stamps, for example). The location, velocity and direction of the user may be used later in the method to provide locationally appropriate messages to the user. Further, the velocity may be used to further identify appropriate message, such as if a user is walking, an offer regarding a special at a nearby coffee shop may be appropriate whereas if the velocity indicates that a user is speeding on a train, a message about an inaccessible coffee shop may not be useful.

Similarly, the computer usage message 320 may be analyzed for a timing element such as whether a user is currently available to act on a communication. As an example and not limitation, is that a computer usage message 320 may use the users calendar to determine appropriate times for a communication to be sent for example, the user may be assumed to be asleep or traveling on an airplane. It may make little sense to communicate an offer that expires in 15 minutes in these cases for example. Similar, if the computer usage messages 320 indicate that a user is walking, communicating an offer that a user could not walk to before the offer expires may makes little logical sense. Other examples include that the computing device 110 may be off, a user state may be set to “away or busy” in an application, a contact me only during these times setting may be employed, etc.

In some embodiments, the computing device 110 may have accessories attached, such as a camera and the accessories may be used as part of the computer usage message 320. The camera may take a photo and the photo may be analyzed to determine if there are any appropriate messages that could be communicated that relate to the photo. Similarly, recordings of voices and scenes may be analyzed to provide useful to create the computer usage message 320.

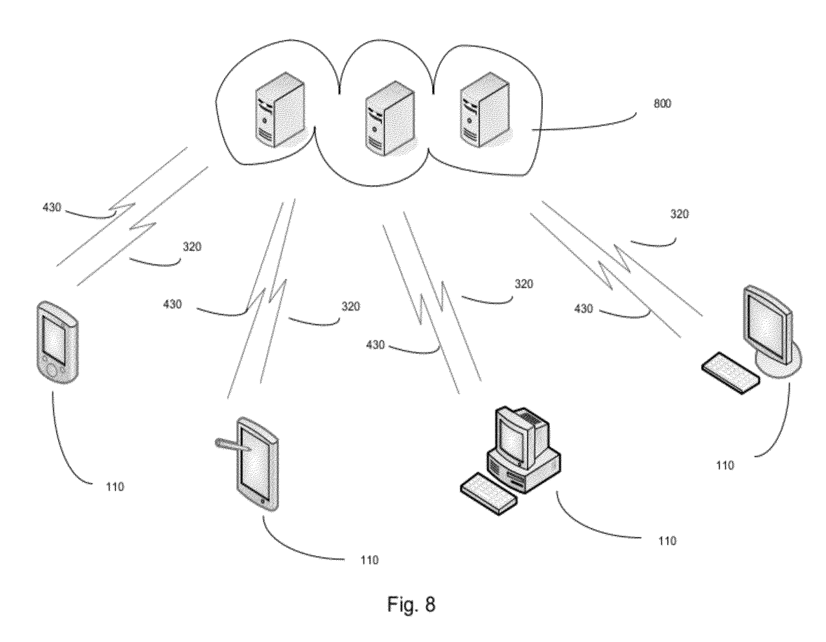

In other embodiments, the user may use more than one computing devices 110. The user profile 300 may be maintained and added to by using computer usage message 320 from the variety of computing devices 110 used by the user. In action, the user may sign in from the various computing devices 110 or the computing devices 110 may be recognizable as belonging to a specific user. The actions taken by a unique user on different computing devices 110 may be accumulated by a central system 800 (FIG. 8) and added to the user profile 300. As just one example, a user may play a video game on a gaming console and this may generate a computer usage message 320 for a user. At the same time, a user may read an email on their portable computing device 110 and this also may generate an additional computer usage message 320.

The computer usage message 320 may be received by one or computing devices acting as a central authority 800 that maintain an application to track the computer usage messages 320. In a traditional environment, the application may operate on a central server or other central authority 800 (FIG. 8). In a distributed or cloud based system, the application may operate in one or more computing devices and the computer usage messages may be received and stored by many different parts of the distributed system of the central authority 800. As mentioned previously, the application may be a dedicated piece of hardware that is physically configured to execute the many embodiments of the method.

In some embodiments, the computer usage message may be created by an application on the computing device 110 and be pushed to a central authority 800 when ever a computer usage activity occurs. On other embodiments, a central authority 800, such as a server, may periodically query the computing device 110 for computer usage messages. Of course, both “pushing” to a central authority 800 and “querying” from the central authority 800 are possible and are contemplated.

At block 205, an analysis may be performed of the computer usage message from the user. The analysis 330 may attempt to break the computer usage message 320 into useful pieces of information. As mentioned previously, a location, a velocity and a direction may be determined by analyzing a series of locations and times of being in those locations such as from a time indicator in the message received from the user on the mobile computing device 110. In a similar fashion, if a user responds to a communication, such as the user opens an email and follows a link, the computer usage 320 response may be analyzed to mean that the communication was found to be of interest to the user. Further, the time it took from when the computer usage message 320 was received to when it was acted upon may also be of use in gauging the perceived value of an offer in a communication. Related, if suggested communication 430 was an offer and required a series of actions and one action was left for last, this information may be analyzed to see if the lingering offer is less desirable, has a technical flaw, etc.

Classifications

The analysis 330 may also attempt to classify a user into classifications. The possible classifications are almost limitless. The purpose of the classifications may be to make identifying possible candidates to receive tailored offers and/or benefits easier. For example, if a store has women's shoes on sale, searching all users to see which has an interest may take a significant amount of time. By selecting the classification “women's shoes”, the process of identifying potential customers may be more efficient but may be broader than proceeding individually, user by user.

Initially, user characteristics may be developed through information obtained from the user, for example, during the registration process and may be used to classify a user. Overtime, data developed through user interaction with the system may further improve the classifications. Such user interaction with the system may further improve classifications. Such user interaction may include both implicit behavior, such as search terms and browsing history and explicit behavior, such as program participation levels, interest profiles, linking to other programs they may be a user of, etc. The characteristics may be used to classify a user. For example, some information used for classification may be age, sex, geographic location information, life events, user value, completed promotions, the types of promotions previously accepted but not yet completed, or by promotions started but abandoned by a user. The classification may be adjusted over time.

Of course, the number and types of classifications possible may be limited only by imagination. Classifications may be based on user interests, such as interests in specific goods or services. In addition, the classifications may be based on where the user lives. Buying patterns may also be used to create classifications. Similarly, users may opt in to classifications in areas of interest. As yet another example and not limitation, a user may opt to receive communications from a specific restaurant about specials at that restaurant.

In addition, the classifications may help create the communications. For example, if a desired classification is desired to undertake an action, then past communications that successfully were able to get some users of the classification to undertake an action may be analyzed to see if a similar offer may be created. For example, an offer of 10,000 credits may have resulted in many users of the classification to undertake an action and an offer of 8,000 credits performed equally well whereas an offer of 1,000 credits may have resulted in a very low response rate from users. Thus, the system would optimize future “like” communications based on this send out an offer for 8,000 credits along with an offer for the same activity for 6,000 credits to determine the most cost-effective combination over time.

Further, vendors may drive classifications. As an example and not limitation, a sports cars dealer may seek a classification for users that have both high disposable income and a demonstrate interest in sports cars, such as searching for known sports cars. Vendors may seek to communicate with users with specific characteristics and categories may be created to collect users that match the desired characteristics.

The classifications may also relate to how the user responds to suggested communications 430. Some users may appreciate the suggested communications 430 while other may not welcome any suggested communications 430 except the most critical communications. Having this knowledge may allow communications to be better tailored to each classification or each individual. Again, the number of classifications and the type of classifications is only limited by imagination as virtually any classification is possible.

In addition, a user may belong to many classifications at the same time. Further, each classification may be given a score that indicates how strongly the user fits in the classification. As an example, a male may have a limited interest in women's shoes in that male only seeks shoes that would be appropriate for a specific female companion. The score for the user may be a medium score. In contrast, a women's shoe salesperson may have interests in all shoes, but especially women's shoes, and the score may be higher.

Similarity Score

In some embodiments, a similarity score may be determined based on the percentage of overlap between a suggested communication 430 and user profile 300 classifications. The similarity score may be compared to a threshold to determine if the suggested communication 430 is sufficiently similar to the profile of the user 300. The threshold may be adjusted through experience. For example, some users may appreciate and act on virtually all suggested communications 430 and the threshold may be low. Other users may not appreciate any suggested communications 430 and may not act on any communication 430, with the threshold for these users being high.

In addition, an authority may also be able to adjust the threshold. For example and not limitation, if the method/system adds new functionality or changes the terms/conditions, the threshold may be lowered to alert the user.

The user may also be able to manually override the threshold. There may be points in time where the user absolutely does not wish to be interrupted and will have no intention of acting on even the most lucrative communication 430. The user may be able to temporarily adjust the threshold such that only the most critical suggested communications 430 are communicated. The user may be able to set threshold modification rules. For example and not limitation, a user may be able to set up a rule to receive notices of expirations, deals of a certain level, or classification, etc.

Known User

The analysis may also review whether the user is known. In some embodiments, the determination of whether a user is known involves having a user submit a user name and a password. The name and password may be verified and the users may proceed. If the name and password are not verified, benefits 720 may not be accrued. The verification may occur at a central server 800 or by a trusted authority in the distributed computing environment. Of course other manners of verifying a user are possible, including more advanced manners such as using cryptography, keys, etc.

As benefits 720 may be offered to certain users, there may be an incentive to “cheat” or take unfair advantage of the various embodiments of the method. For example, a single user may set up a plurality of profiles on one or more computers 110 and attempt to use the various user profiles 300 to gather an unfair number of benefits 720. In some embodiments, a computer fingerprint may be used to ensure that a single computer is not used to generate a plurality of fraudulent accounts on a single computer.

Fingerprinting

The computer fingerprint may be stored in a way that does not identify the user but does ensure that the same computer is not being used to generate a plurality of fraudulent accounts, for example, verifying that the computer fingerprint is unique. The computer fingerprint may be one or more unique codes associated with different part of a computer such as a processor 120 identification code, a hard drive 141 identification code, a MAC address, an operating system identification code, a memory 130 identification code, an internet application identification code, an operating system update identification code, a keyboard identification code, a sound device identification code and a display device identification code. Of course, other codes and code combinations are possible and are contemplated. The codes may be analyzed by studying the combination of hardware attributes, the uniqueness of the attributes and how the attributes vary in different scenarios to identify which combinations are typical and which are not. If the combination is not typical, further investigation may be warranted to determine if fraud is possible and to differentiate fraud from false positives. If the fraud is determined to be present, the method may end and benefits 720 may not be accrued. In addition, the items used to create the fingerprint may be adjusted over time to avoid a user trying to defeat the system.

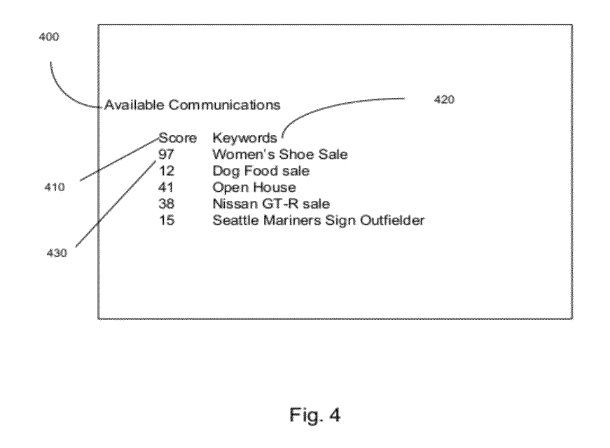

At block 210, a result of the analysis may be stored in a user profile 300. The user profile 300 may be a storehouse of knowledge about the user that is used to selected or create a desired communication(s) 430 (FIG. 4) to be provided to the user. The user profile 300 user may also include more than just facts but also the analysis 330 from block 205. For example, the user profile 300 may include a value of a consumer to a certain type of marketer, a volume of business by a consumer or an amount of revenue of business by a consumer.

In some embodiments, the analysis 330 in the user profile 300 may include classifications. As mentioned previously, classifications may be groups of people with similar interests, behavioral patterns, or other profile characteristics. The suggested communications 430 may be communicated to all users with a same classification.

At block 215, a suggested communication 430 from a plurality of available communications 400 for the user may be determined. In one embodiment, at least one of the suggested communications 430 from the available communications 400 may be determined as being most closely related to the user profile 300. Using the previous example, an available communication 400 related to women's shoes may be determined to be the suggested communication 430.

The suggested communication 430 may be virtually any electronic communication form. In general, the suggested communications 430 may be an attempt to modify or direct behavior by offering benefits to a user in exchange for the user taking one or more actiosn. The purpose of the suggested communication 430 is to attempt to direct behavior in a manner that is not overwhelming or threatening. The suggested communications 430 merely are attempts at suggesting behavior to a user and the user has no obligation to respond to the suggested communications 430 but may gain benefits 720 if they do respond to the suggested communications 430. In other embodiments, the suggested communication 430 may relate to a specific item.

In addition, the suggested communication 430 may be a newly created suggested communication 430. The method may take into account the user profile 300 and design a suggested communication 430 and corresponding benefit(s) 720 specifically for a user or for a classification of users. The suggested communication 430 may vary virtually any aspect of the suggested communication 430 to create a new suggested communication 430 that is more likely to entice a user to take action on the suggested communication 430. As one example, in the past a user acted on a suggested communication 430 if the benefit was a 25,000 credits, the new suggested offer 430 may also offer 25,000 credits as the benefit 720. Similarly, the form of the suggested communication 430 may also affect the probability that the user will act on the suggested communication 430. As an example, a suggested communication 430 that is large file may not be acted upon by a user with a dial up connection to the file but the user may respond to suggested communication 430 that is a smaller text file.

At block 220, it may be determined if the suggested communication 430 is sufficiently similar to the user profile 300 by determining if the suggested communications 430 ranks over a threshold of the user profile 300. In some embodiments, the similarity score 410 is used to determine if the available communication is over the threshold. The similarity score 410 may be determined in many ways. In one embodiment, a comparison of keywords 420 in the suggested communication 430 is compared to keywords in the user profile 300. In additional embodiments, a weighting may be applied to more recently added keywords in the user profile 300. In addition, the weighting may be applied to different parts of the user profile 300. For example, a suggested communication 430 that contains an offer of goods may be more closely related to searches by the user and logically, the searches in the user profile 300 may be given a greater weight. In additional embodiments, learning logic such as artificial intelligence is used to predict which offers which will have a higher probability of interesting the user and having the user perform the desired behavior. In addition, the similarity scores 410 may be calculated for classification of user profiles 300. The threshold may be modified by an authority or through the analysis 330. In addition, the threshold may be modified for each suggested communication or for each customer or for each category.

The similarity score may also be used when designing a suggested communication 430. For example, if a vendor desires a user to use Hotmail, sample suggested communication 430 may be tested against the desired audience to determine the similarity score. Ideally, the suggested communication 430 will have a high similarity score and will entice users to act on a suggested communication 430 as desired.

At block 225, if the suggested communication 430 is determined to be sufficiently similar to the profile of the user, the suggested communication 430 may be provided to the user. The suggested communication 430 may be provided in a variety of ways. In one embodiment, a download file may be prepared that incorporates both code that displays the first promotion, and, optionally, code for an activity monitor that monitors activity of the user on a computer to determine completion of the activity set.

In one embodiment, the activity monitor code may be downloaded when first using or joining the method.. In that case, the monitoring parameters only may be downloaded with respect to a particular promotion. Other options for distributing monitor code or parameters may be employed. The download file may be a web page including not only HTML script, but may also include dynamic HTML (DHTML), XML, JavaScript, Java applets, etc. Of course, any technology that would allow an application or device to display the suggested communication 430 is acceptable.

The code that displays the promotion may be actual displayable code or may simply be text or a description language that is used to generate the displayed view of the promotions. Similarly, the code for the activity monitor may be actual code that runs on the user computer 110 and watches for specific events or may be a description of targets or triggers that may be used by a program already present on the computer 110, such as a dedicated system toolbar or a particular function in a more general client computing device 110 application.

Once the download file is prepared, the download file may be sent to a computer 110 or one or more other electronic devices associated with the specific user. The process of sending may be in response to a request from one of the user's various computing devices 110. It one embodiment, the request may be generated by the toolbar 520 (FIG. 5) or toolbar system function. The request may be timed and periodic, or may be in response to a particular user action. It should be understood that the time delay for execution of the above steps may be minimal, for example, an interaction on the toolbar, such as a search request, may prompt a request to the system that then develops and delivers a promotion related to the search request. To illustrate, a search request for information on translating text may result in delivery of the search results and a promotion that involves a suggested communication 430 for the user to use a particular website for translating for a benefit 720 of several points.

The computer 110 may display a graphical user interface element with a plurality of selections including a system selection button. Referring briefly to FIG. 5, a portion of a web page 500 illustrates a web page header 510, and a toolbar 520. The toolbar 520 may include a benefits button 530. In an alternative embodiment, the selection of a promotion may be implicit by merely starting an activity. For example, some applications may have inherent promotions associated with them.

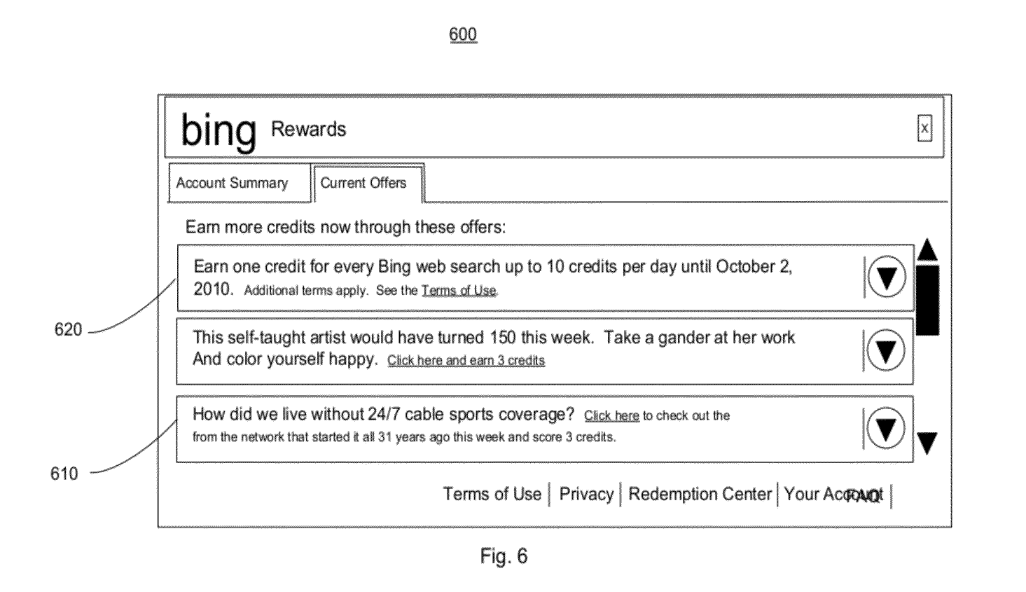

The benefits page may include a list of current promotions being offered. The display of a promotion may include the one or more activities (the activity set) associated with a promotion and a related benefit 720 for completing the activities. Turning briefly to FIG. 6, an exemplary benefit redemption page 600 illustrating various suggested communications 430 such as promotion offers, is discussed and described. The benefits page 600 shows one promotion 610 benefiting 3 benefit points for following a link. Another promotion 620 shows a type of compound offer allowing the user to collect up to 10 points a day until an expiration of the offer. Another promotion (not depicted) may offer a benefit 720 for setting a browser home page to a search engine for at least 30 days and performing 10 searches using the search engine in that 30 day period. Another promotion (not depicted) may offer a benefit 720 for using a thesaurus in a word processor. All of these promotions may be considered suggested communication 430 and may be designed to entice a user to act upon the suggested communications 430.

At block 230, one the suggested communication 430 may be removed from the available communications 400 for the user for a period of time. The period of time for removing the suggested communication 430 from the available communications for the user further may be a time that either eliminates repeat communications or creates an expiration for the communication.

At block 235, a computer usage message 320 in response may be received indicating whether the suggestion communication 430 was acted upon or not acted upon. At block 240, if the suggested communication 430 was acted upon, a benefit 720 may be provided to the user. A message may be sent to the user indicating achievement of the benefit 720 and preferably, a total of benefits 720 available and a total of all benefits 720 received. In one embodiment, the message is displayed on a benefits web page 700, but may be sent via text message, email, etc., or by a combination of these. Further, the vendor may agree to pay for, supply or redeem credits or other benefit 720 provided to the user if the acts in the desired manner.

Benefits 720 earned may be immediately added to a consumers account and may be used or redeemed immediately after being added to the consumers account. The benefit 720 may be displayed or redeemed at a local merchant via the mobile computing device 110. As an example, a user may be walking and may desire coffee. The user may recall receiving a suggested communication 430 that stated free coffee is available at store A if a survey is completed. The user may enter the coffee store A, complete the survey on their mobile computing device 110. The completion of the survey may result in an electronic coupon being delivered in seconds (depending on communication rates) and the electronic coupon may be used in real time to receive free coffee virtually immediately after filling out the survey.

The benefit 720 could be virtually any thing of value to a user. Sample benefits 720 included earning a credit, earning a sweepstake entry, earning a coupon, earning a discount, earning access to exclusive content, earning access to premium content, earning a customized experience, earning access to additional tiers and earning access to additional status. In an additional embodiment, benefit 720 per action (such as a search) ratio may be adjusted for a user, either as a benefit 720 to the user or as a detriment to the user, depending on the analysis of the actions of the user.

In some embodiments, a user completes multiple steps to receive the benefit 720. For example, the benefit 720 may be earned by visiting a series of URL (uniform resource locators). The method may track the order and timing of the URL visits and this data may be further analyzed.

In some embodiments, the benefit 720 may be earned for setting and maintaining a desired setting for a period of time or number of uses within a web based application or on a client application or device. The desired setting may be a default search engine, a home page, a mapping application, a word processing application, etc.

FIG. 7 is an exemplary screen shot of a system redemption page 700, such as might be displayed at the completion of a promotion. A window area 710 may show various items available for redemption and their associated redemption value. A balance display area may show the user's current benefit value. The balance may be in points or in monetary currency where the user may be able to select the desired currency from a plurality of currencies.

At block 245, an additional analysis of the response computer usage message 320 communicated from the user may be performed. The additional analysis of the computer usage message 320 communicated from the user may include determining the order in which an offer was acted upon or ignored and the time in which an offer was acted upon or ignored. The user may be further classified into user classifications based on the results and the additional result.

The ability to vary promotions and benefits and to target users or user groups is not limited to take up rate testing. For example, promotions may be dynamically developed and modified simply to try to better match the interests of a user and the user's perceived interest in participating in various promotions. The user profile 300 based on analysis of previous responses to suggested communications 430 may be used as a basis for developing a user's next suggested communication 430. For example, a user who rarely participates in suggested communications 430 such as promotions may be offered more attractive promotions as suggested communications 430 involving fewer activities and greater benefits 720 to try to entice the user into participation. A user who routinely participates may be given a wider variety of activities to keep his or her interest. In one embodiment, the benefit rate, that is, the number, the value of and frequency of promotions may be dynamically modified based on completion of the one or more activity sets.

For example, a comparison of completion rates of between a first and a second benefit groups or users may be performed. Those in the marketing industry are aware of the various analysis tools available to perform such a comparison. Depending on the nature of the differences between promotions and factoring any difference in demographics (or any other profile or behavioral characteristics) of the users of the first and second benefit groups, a picture of demand elasticity may be developed. Additional data may be developed by repeating this process for additional benefit groups and additional related promotions, either separately or at the same time.

Optionally, during the creation of the suggested communication 430 such as a promotion, a valid time period may be added to the suggested communication 430 limiting to a particularly time period or number of days during which the user can earn the suggested communication 430, which may be a promotion. The valid time period may be influenced by previous behavior or may simply be related to capturing take up rate data in a given time frame. When a valid time period is employed, the valid time period may be incorporated into the download file and used by the user computer to display the suggested communication 430 only during the valid time period. In addition, the valid time period may be used at the user computer 110 to locally generate reminders about upcoming deadlines for completion of time-sensitive suggested communication 430 apart from messages sent by the system host. The time period may be adjusted during the course of the promotion. For example, completion of certain activities may extend the time period for completion.

The valid time period may be based on the characterization of the user in the user profile 300. In one example, a user may be characterized as frequent or occasional, related to their current habits of participation in suggested communications 430 such as promotions. In this example, the valid time period may be set shorter for the frequent user than for the occasional user, benefiting the frequent user with more opportunities to accumulate benefits 720. Alternatively, an occasional user may be given a shorter valid time period in order to present as many promotions as possible to encourage participation in at least some promotions. Fortunately, the system 200 provides the flexibility to operate in support of either motivation.

Additional restraints may be placed on completion of activities. For example, if an activity set involves multiple uses of a particular website's functionality, the total number of accesses of the website before completion may be limited. To illustrate, an online chat tool may be found at a search website. To encourage use and familiarization with the chat tool, it may be specified that the chat tool must be used 5 times in the next 10 times (or within a defined time period) the search website is accessed.

At block 250, an additional result of the further analysis may be stored in the user profile 300. As a result, the user profile 300 will continue to grow, be refined and reflect the most recent activities of a user and may be used for further classification.

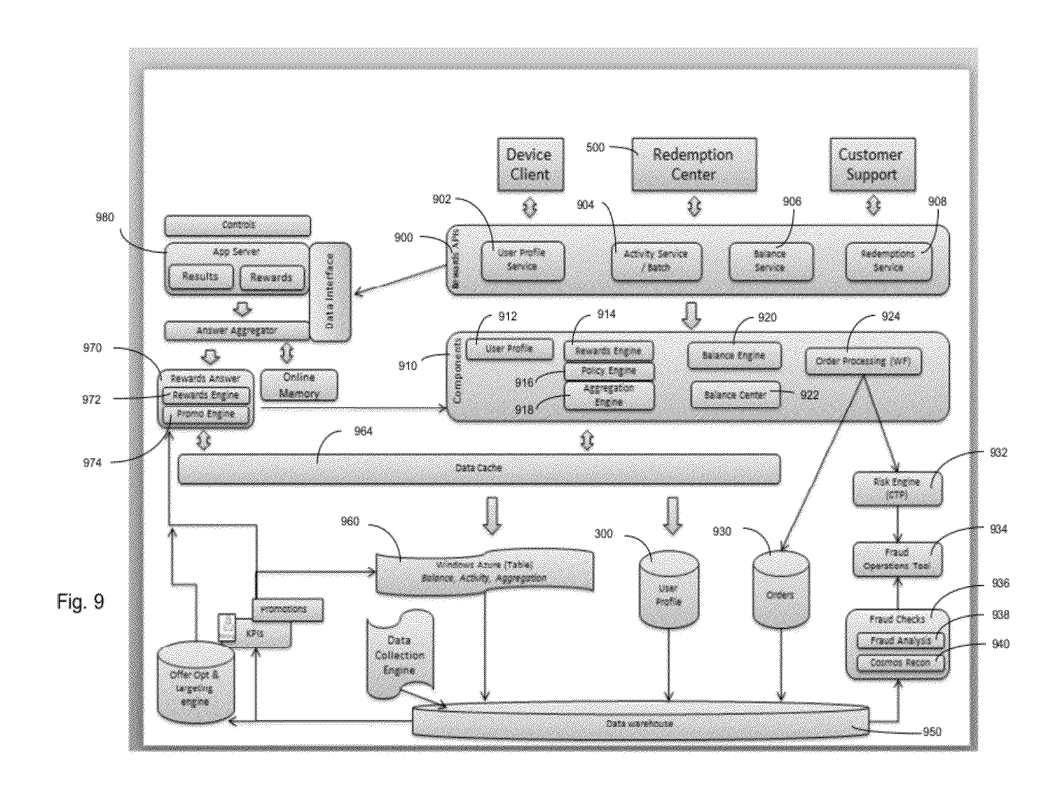

FIG. 9 illustrates one embodiment of the system. A user interface 500 such as a toolbar may be displayed to the user. The user interface 500 may interact with various applications 900 which may provide data to be displayed on the user interface 500 such as a user profile service 902 which may maintain data related to a user profile 300 component, an activity service 904 which may track the activities by a user, a balance service 906 which may track the balance for a user and a redemption service 908 which may assist a user in applying benefits such as points. Similarly, the applications 900 may communicate with various components 910. Some of the components 910 may include the a profile component 912, a rewards engine 914 which may track the available rewards or benefits 720, a policy engine 916 which may track the various policies regarding assigning benefits 720 and an aggregation engine 918 that may aggregate user data from a variety of computing devices 110 and applications. There may also be a balance engine 920 which may track and help calculate a balance of user benefits 720, a balance center in which vendors and authorities may assign benefit levels to various tasks and an order processing 924 application which may assist in user purchases.

The order processing component 924 may also communicate with an order storage device 930 where orders are stored. In addition, the order processing component 924 may communicate with a risk engine 932 that may be used to determine a fraud risk level for an order. The Risk engine 932 may communicate with a fraud operation tool 934 that may be designed to communicate with a fraud checks application 936 which may use a fraud analysis application 938 and other fraud related applications 940.

A data cache 964 may communicate with the benefit components 910 along with the additional tracking application 960 and the user profile 300 to keep data quickly available for rapid display. A rewards answer application 970

The user profile 300, the order storage 930 and the fraud check 396 may access a data warehouse 950 to store data in a reliable manner. Similarly, an additional tracking application 960 may organize and store data in the data warehouse 950 for rewards balance, user activity and aggregation activities. The rewards/benefit answer application 970, which may include a rewards engine 972 and a promo engine 974, may also communication with the data cache 964. Finally, the application server 980 may communicate with the reward answer application 970 to display the user interface 500 which may accept input from a user which may be fed to the reward applications 900 and the process may continue.

The ability to create suggested communications 430 having unique variations and to assign those promotions to users or classifications of system users provides a value to system operators by allowing them to create related suggested communications 430 in order to test factors that affect take up rate on a suggested communications 430. Perhaps more importantly, the ability to dynamically create promotions based on user characteristics allows generation of suggested communications 430 tailored to appeal to the specific user while acknowledging his or her interest in participating in the activities related to the suggested communications 430. Benefits 720 may be used to perform any activity that a device can verify and report back on (e.g., check in at a location, time, click behavior, etc.). As an example, the benefits 720 may encourage a user to try new features of application programs or websites, or to try new websites. The system can also benefit advertisers by offering better characterization of potential consumers through the use of characterization data generated through user interaction with the system.

As a result of the system, user loyalty may be generated. By observing user responses in the form of computer actions (or non actions) to a variety of suggested communications 430, a more sophisticated user profile 300 may be created. By analyzing the ever more sophisticated user profile 300, tailored suggested communications 430 may be created. By supplying suggested communications 430 that are intelligently tailored to a specific user or category of users, users will learn to trust the suggested communications 430, appreciate the benefits that result from acting on the tailored suggested communications 430 and will act on the ever increasing tailored suggested communications 430 with increasing regularity. The system will become much more than advertisements but a trusted source of valuable suggested communications 430 that steer a user in a desired manner of action which may benefit a vendor without offending the user.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

1. A method of analyzing computer usage on a computing device to deliver targeted communications comprising;
Receiving a computer usage message;
Performing an analysis of the computer usage message;
Storing a result the analysis in a user profile for a user;
Determining a suggested communication from a plurality of available communications for the user comprising determining at least one of the plurality of available communications as being most closely related to the user profile;
Determining if the suggested communication is sufficiently similar to the user profile comprising determining if the suggested communications ranks over a threshold of relevancy for the user profile;
If the suggested communication is determined to be sufficiently similar to the user profile,
Providing the suggested communication to the user;
Removing the suggested communication from the available communications for future use to the user for a period of time;
Receiving a response computer usage message indicating whether the suggested communication was acted upon or not acted upon;
If the suggested communication was acted upon and completed, providing a benefit to the user;
Performing an additional analysis of the response computer usage message communicated from the user; and
Storing an additional result of the additional analysis in the user profile.

2. The method of claim 1, wherein the user profile further comprises at least one selected from a group comprising:
a value of a consumer to a marketer or
a volume of business by the consumer or
an amount of revenue of business by the consumer.

3. The method of claim 1, wherein the user profile comprises classifications which apply to the user and the suggested communication comprise suggestion classifications which apply to the suggested communication.

4. The method of claim 1, further comprising classifying the user into user classifications based on the result and the additional result wherein the classification of the user is with additional users that have similar results.

5. The method of claim 4, wherein a similarity score is determined based on a percentage of overlap between the suggested communication and the classifications in the user profile and the similarity score is compared to a threshold to determine if the suggested communication is sufficiently similar to the user profile.

6. The method of claim 1, wherein the user completes multiple steps to receive the benefit and wherein an order and timing of the steps is tracked.

7. The method of claim 1, wherein the computer usage message is from a first computing device and the response computer usage message is from a second computing device thereby allowing multiple computing devices to create multiple computer usage messages for the same consumer.

8. The method of claim 7, wherein the first computing device or the second computing device is a mobile computing device.

9. The method of claim 8, wherein the benefit may be displayed or redeemed at a local merchant via the computing device.

10. The method of claim 1, wherein the computer usage message comprises a location indication of the user and a time indicator.

11. The method of claim 1, wherein determining whether communicating the suggested communication is appropriate at a current time further comprising determining if the user is currently available to act on the suggested communication.

12. The method of claim 1, wherein the method utilizes a computing device appropriate application stored on each of the computing device to display a user interface and wherein the benefit is indicated on the user interface.

13. The method of claim 5, wherein the threshold may be modified by:
an authority; or
a threshold analysis; or
for each of the suggested communication; or
for each customer.

14. The method of claim 1, wherein benefits earned are immediately added to a consumers account and may be used immediately after being added to the consumers account.

15. The method of claim 1, wherein a computer fingerprint is used to ensure that a single computer is not used to generate a plurality of fraudulent accounts on the single computer.

16. The method of claim 1, wherein the benefit is earned for setting and maintaining a desired device or application setting for a benefit period of time or number of uses.

17. A computer system for analyzing computer usage on a computing device to deliver targeted communications comprising a processor physically configured according to computer executable instruction, a memory in communication with the processor and an input/output circuit, the computer executable instructions comprising instructions for:
Receiving a computer usage message;
Performing an analysis of the computer usage message;
Storing a result the analysis in a user profile for a user wherein the user profile further comprises at least one selected from a group comprising:
a value of a consumer to a marketer or
a volume of business by the consumer or
classifications which apply to the user or
an amount of revenue of business by the consumer;
Determining a suggested communication from a plurality of available communications for the user comprising determining at least one of the plurality of available communications as being most closely related to the user profile;
Determining if the suggested communication is sufficiently similar to the user profile comprising determining if the suggested communications ranks over a threshold of relevancy for the user profile;
If the suggested communication is determined to be sufficiently similar to the user profile,
Providing the suggested communication to the user;
Removing the suggested communication from the available communications for future use to the user for a period of time;
Receiving a response computer usage message indicating whether the suggested communication was acted upon or not acted upon;
If the suggested communication was acted upon and completed, providing a benefit to the user;
Performing an additional analysis of the response computer usage message communicated from the user; and
Storing an additional result of the additional analysis in the user profile.

18. The computer system of claim 17, further comprising
classifying the user into user classifications based on the result and the additional result wherein the classification of the user is with additional users that have similar results and wherein a similarity score is determined based on a percentage of overlap between the suggested communication and the classifications in the user profile and the similarity score is compared to a threshold to determine if the suggested communication is sufficiently similar to the user profile.

19. The computer system of claim 17, wherein the computer usage message is from a first computing device and the response computer usage message is from a second computing device thereby allowing multiple computing devices to create multiple computer usage messages for the same consumer and wherein the first computing device or the second computing device is a mobile computing device.

20. The computer system of claim 17, wherein a computer fingerprint is used to ensure that a single computer is not used to generate a plurality of fraudulent accounts on the single computer.
